(19) United States
(12) Patent Application Publication
(10) Pub. No.: US 2018/0213747 A1
(43) Pub. Date: Aug. 2, 2018

(54) Feed Distribution System

(71) Applicant: Henry Thomas Wegehaupt, Dimock, SD (US)

(72) Inventor: Henry Thomas Wegehaupt, Dimock, SD (US)

(21) Appl. No.: 15/418,899

(22) Filed: Jan. 30, 2017

(51) Int. Cl. A01K 5/02; B65G 15/00; B65G 15/08; B65G 15/40; B65G 21/20; B65G 39/04; B65G 39/12; A01K 5/00; A01K 5/01

(52) U.S. Cl. CPC A01K 5/0283; B65G 15/00; B65G 15/08; B65G 15/40; B65G 21/2081; A01K 5/0291; B65G 39/12; A01K 5/0208; A01K 5/007; A01K 5/01; B65G 39/04

(57) ABSTRACT

A feed distribution system distributes feed from a distribution vessel directly to a conveyor assembly having a belt forming a trough from which animals are fed. The system includes a distribution vessel. The distribution vessel has an output opening for distributing animal feed from the distribution vessel. A conveyor assembly extends from the distribution vessel to receive the animal feed. The conveyor assembly includes a trough conveyor which has an upper surface defining the trough from which animals may feed directly.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to feed distribution systems and more particularly pertains to a new feed distribution system for distributing feed from a distribution vessel directly to a conveyor assembly including a trough conveyor from which animals are fed.

### BRIEF SUMMARY OF THE INVENTION

An embodiment of the disclosure meets the needs presented above by generally comprising a distribution vessel. The distribution vessel has an output opening for distributing animal feed from the distribution vessel. A conveyor assembly extends from the distribution vessel to receive the animal feed. The conveyor assembly includes a trough conveyor which has an upper surface defining a well to act as a trough from which animals may feed directly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a feed distribution system according to an embodiment of the disclosure.

FIG. 2 is a top front side perspective view of an embodiment of the disclosure.

FIG. 3 is a cut away front view of a trough conveyor of an embodiment of the disclosure.

FIG. 4 is a cut away front view of a trough conveyor of an embodiment of the disclosure.

FIG. 5 is a cut away front view of a trough conveyor of an embodiment of the disclosure.

FIG. 6 is a schematic view of an embodiment of the disclosure.

### DETAILED DESCRIPTION OF THE INVENTION

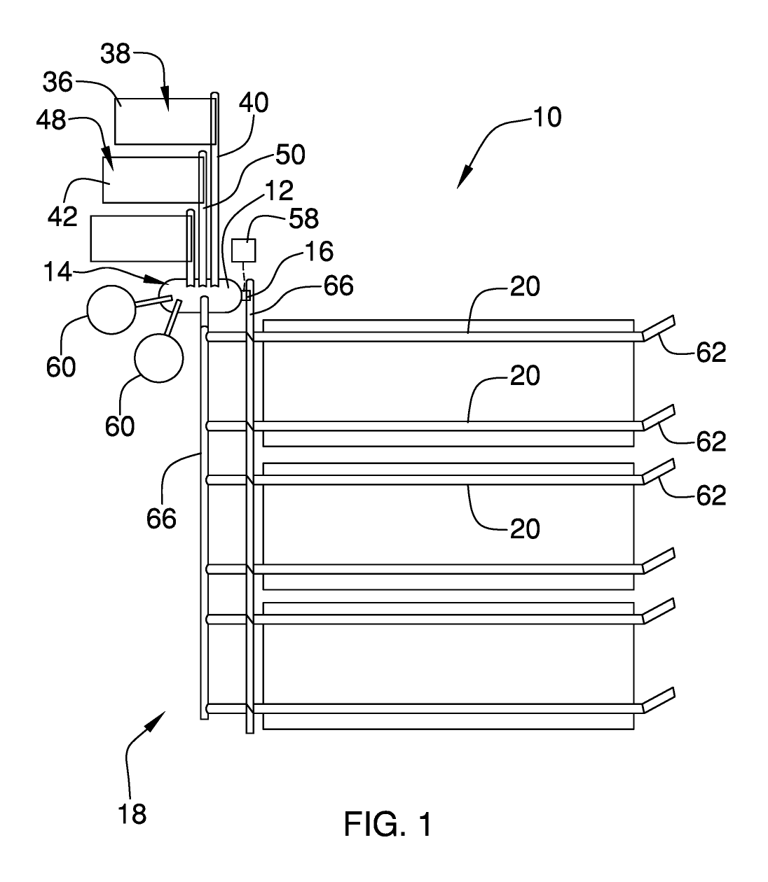

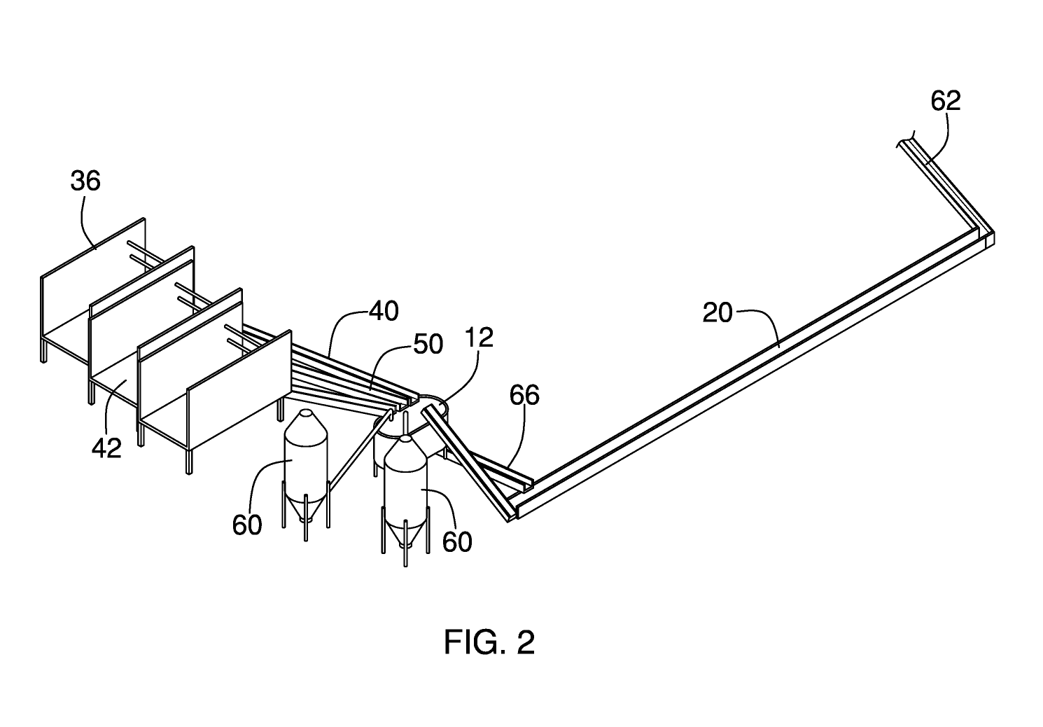

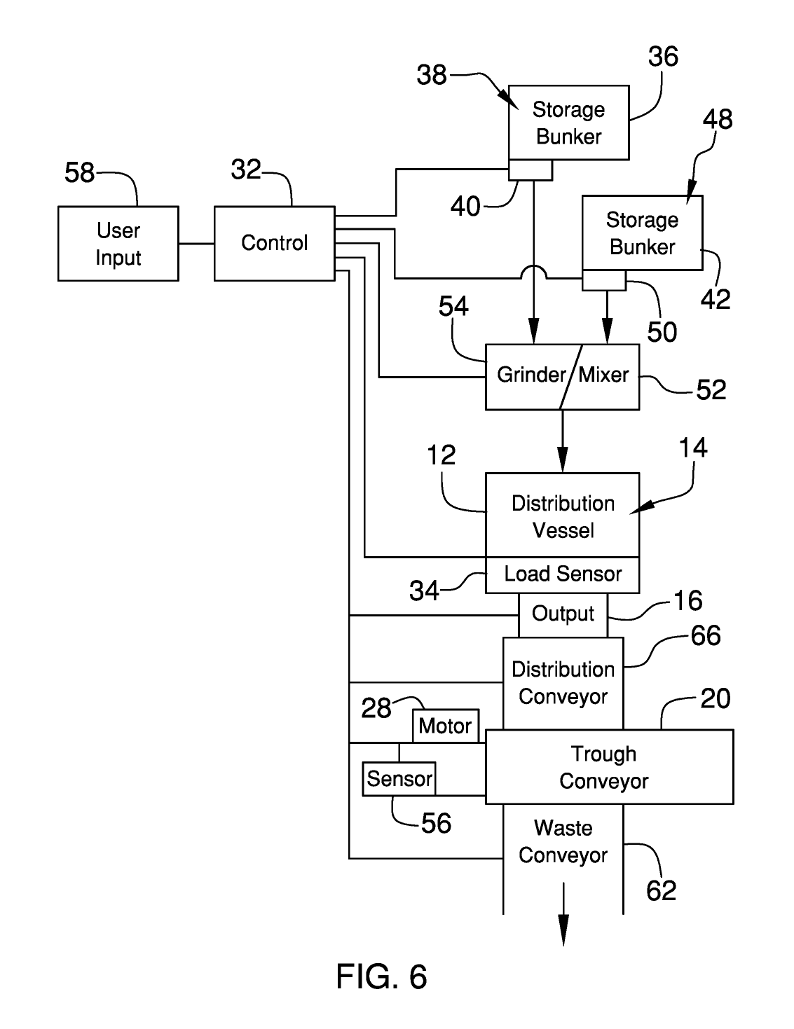

With reference now to the drawings, and in particular to FIGS. 1 through 6 thereof, a new feed distribution system embodying the principles and concepts of an embodiment of the disclosure and generally designated by the reference numeral 10 will be described.

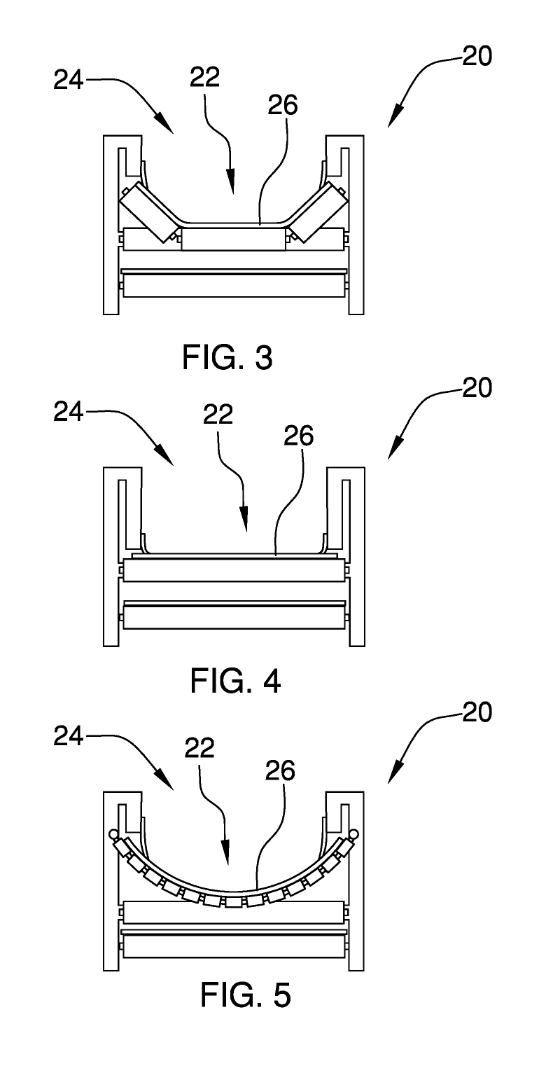

As best illustrated in FIGS. 1 through 6, the feed distribution system 10 generally comprises a distribution vessel 12 configured for containing and holding animal feed 14. The distribution vessel 12 has an output opening 16 configured for distributing the animal feed 14 from the distribution vessel 12. A conveyor assembly 18 extends from the distribution vessel 12. The conveyor assembly 18 is positioned proximate to the output opening 16 wherein the conveyor assembly 18 is configured for receiving the animal feed 14 distributed from the distribution vessel 12. The conveyor assembly 18 includes a trough conveyor 20. The trough conveyor 20 has an upper surface 22 defining a well 24 extending along the trough conveyor 20 wherein the trough conveyor 20 is configured for holding the animal feed 14 therein and forming a trough from which animals have direct access to the animal feed 14. The upper surface 22 of the trough conveyor 20 is defined by a belt 26 extending continuously along a length of the trough conveyor 20. A motor 28 is coupled to the conveyor assembly 18 such that the motor 28 moves the belt 26. The trough conveyor 20 may have various well shapes and utilize conventional alternative conveyor structures as exemplified in FIGS. 3 through 5. The shaping of the upper surface 22 may be achieved in a conventional manner as conveyor assemblies generally having a concavity or other known means for containment of matter on the conveyor assembly are known but have not heretofore been known or modified for feeding of animals as herein described.

A distribution control assembly 30 is coupled to the distribution vessel 12. The distribution control assembly 30 is configured for metering distribution of the animal feed 14 from the distribution vessel 12 onto the conveyor assembly 18. A control 32 in the nature of a conventional control circuit, central processing unit, or the like, is operationally coupled to the distribution control assembly 30 and the motor 28 wherein the control 32 coordinates metering of distribution of the animal feed 14 from the distribution vessel 12 and movement of the continuous belt 26 for providing a desired amount of animal feed 14 per unit length of the continuous belt 26. A load sensing device 34 is coupled to the distribution vessel 12 and operationally coupled to the control 32. Distribution over time is controlled by the distribution control assembly 30 and the control 32. Thus, distribution over time is controllable by the control 32 using weight detected within the distribution vessel 12 by the load sensing device 34. The distribution control assembly 30 may employ conventional structures, such as augers, vanes, gates, or the like, for selectively withholding and distributing the animal feed 14 from the distribution vessel 12.

A first storage bunker 36 may be configured for storing a first component 38 of the animal feed 14. A first input transport conveyor 40 is operationally coupled between the first storage bunker 36 and the distribution vessel 12 wherein the first input transport conveyor 40 is configured for delivering contents of the first storage bunker 36 into the distribution vessel 12. Similarly, a second storage bunker 42 may be configured for storing a second component 48 of the animal feed 14. A second input transport conveyor 50 is operationally coupled between the second storage bunker 42 and the distribution vessel 12 wherein the second input transport conveyor 50 is configured for delivering contents from the second storage bunker 42 into the distribution vessel 12. Each of the first storage bunker 36 and the second storage bunker 42 may employ a live floor to facilitate delivery of the first component 38 and the second component 48 from the first storage bunker 36 and the second storage bunker 42.

A mixer 52 is operationally coupled between the first storage bunker 36, the second storage bunker 42, and the output opening 16, either inside or outside of the distribution vessel 12, wherein respective contents of the first storage bunker 36 and the second storage bunker 42 are mixed by the mixer 52 to form the animal feed 14 in the distribution vessel 12. When inside the distribution vessel 12, the mixer 52 may be utilized to mix ingredients from any storage or source delivered into the distribution vessel 12. The mixer 52 may include a grinder 54 of conventional design wherein the grinder 54 is configured for grinding the animal feed 14 before the animal feed 14 is distributed from the distribution vessel 12 through the output opening 16.

A motion sensor 56 is coupled to the conveyor assembly 18. The motion sensor 56 detects a speed of the conveyor assembly 18. The motion sensor 56 is operationally coupled to the control 32 wherein a distribution of animal feed 14 onto the conveyor assembly 18 is calculable using data collected from the motion sensor 56 and the load sensing device 34. In a configuration in which a speed of the conveyor assembly 18 is constant, the motion sensor 56 may simply detect motion as opposed to speed. A user input 58 is operationally coupled to the distribution control assembly 30 wherein the user input 58 is configured for setting a desired amount of animal feed 14 to be distributed from the distribution vessel 12 through the output opening 16. The user input 58 may generally be of a mechanical or an electronic nature. The control 32 is operationally coupled to the user input 58 wherein the control 32 is configured to control metering of the animal feed 14 distributed from the distribution vessel 12 responsive to manipulation of the user input 58 by a user. The user input 58 may also be used to set and control mixtures of the first component 38 and second component 48 forming the animal feed 14. At least one storage silo 60 may be operationally coupled to the distribution vessel 12 for delivering contents of the storage silo 60 directly into the distribution vessel 12. The mechanism for delivering contents of the storage silo 60 into distribution vessel 12 may also be operationally controlled by the control 32 and the user input 58.

Alternatively, or in combination with the previously described motion sensor 56, a torque sensor 80 may be operationally coupled to the conveyor assembly 18, or more specifically to the trough conveyor 20. The torque sensor 80 is operationally coupled to the control 32 for determining torque required for movement of the trough conveyor 20 and calculating the amount of feed on the trough conveyor 20 by comparison to torque required for moving the trough conveyor 20 when empty.

The conveyor assembly 18 may also include a waste conveyor 62 operationally coupled to the trough conveyor 20 such that the waste conveyor 62 is configured to transport unused feed and debris out of the trough conveyor 20 and away from the distribution vessel 12. The waste conveyor 62 has an open distal end 64 relative to the trough conveyor 20 wherein the waste conveyor 62 is configured for delivering unused feed and debris from the trough conveyor 20 into an extrinsic receptacle such as a wagon or other disposal container. The conveyor assembly 18 may also be run in a reverse direction in which unused feed is returned towards the distribution vessel 12.

The system 10 may employ various configurations incorporating different placements and numbers of the above components. The system 10 may provide a single trough conveyor 20 extending directly from the distribution vessel 12, a single trough conveyor 20 served by a single distribution conveyor 66 extending between the distribution vessel 12 and the trough conveyor 20, or a plurality of trough conveyors 20 extending from a common distribution conveyor 66 or respective distribution conveyors 66 extending between the distribution vessel 12 and the trough conveyor or conveyors 20. Further, the term conveyor as used herein may include belts, scoops, augers, or other conventional structures for moving animal feed 14 except where particular structures are claimed and the other structures would be incompatible with the claimed structure.

In use, the user controls distribution of animal feed 14 through the user input 58. The control 32 coordinates the operations of the other elements described above to provide desired even distribution along a length of the trough conveyor 20. Waste and clean up is reduced as the animal feed 14 is delivered directly to the conveyor assembly 18 and the conveyor assembly 18 includes the trough conveyor 20 from which animals eat.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A feed distribution system comprising:
a distribution vessel configured for containing and holding animal feed, said distribution vessel having an output opening configured for distributing the animal feed from the distribution vessel; and
a conveyor assembly extending from said distribution vessel, said conveyor assembly being positioned proximate to said output opening wherein said conveyor assembly is configured for receiving the animal feed distributed from said distribution vessel, said conveyor assembly including a trough conveyor, said trough conveyor having an upper surface, said upper surface defining a well extending along said trough conveyor wherein said trough conveyor is configured for holding the animal feed therein.

2. The system of claim 1, further comprising said upper surface of said trough conveyor being defined by a belt extending continuously along a length of said trough conveyor.

3. The system of claim 1, further comprising a distribution control assembly coupled to said distribution vessel, said distribution control assembly being configured for metering distribution of the animal feed from said distribution vessel onto said conveyor assembly.

4. The system of claim 1, further comprising a motor coupled to said conveyor assembly such that said motor moves said belt.

5. The system of claim 2, further comprising:
a distribution control assembly coupled to said distribution vessel, said distribution control assembly being configured for metering distribution of the animal feed from said distribution vessel onto said conveyor assembly;
a motor coupled to said conveyor assembly, said motor moving said continuous belt; and
a control operationally coupled to said distribution control assembly and said motor wherein said control coordinates metering of distribution of the animal feed from said distribution vessel and movement of said continuous belt for providing a desired amount of animal feed per unit length of said continuous belt.

6. The system of claim 5, further comprising a load sensing device operationally coupled to said distribution vessel and said control wherein distribution over time is controlled by said control using weight detected within said distribution vessel by said load sensing device.

7. The system of claim 1, further comprising:
a first storage bunker, said first storage bunker being configured for storing a first component of the animal feed;
a first input transport conveyor operationally coupled between said first storage bunker and said distribution vessel wherein said first input transport conveyor is configured for delivering contents of said first storage bunker into said distribution vessel.

8. The system of claim 7, further comprising:
a second storage bunker, said second storage bunker being configured for storing a second component of the animal feed; and
a second input transport conveyor operationally coupled between said second storage bunker and said distribution vessel wherein said second input transport conveyor is configured for delivering contents from said second storage bunker into said distribution vessel.

9. The system of claim 8, further comprising a mixer being operationally coupled between said first storage bunker, said second storage bunker, and said distribution vessel wherein respective contents of said first storage bunker and said second storage bunker are mixed by said mixer to form the animal feed in said distribution vessel.

10. The system of claim 9, further comprising said mixer including a grinder wherein said grinder is configured for grinding the animal feed before the animal feed is distributed from said distribution vessel through said output opening.

11. The system of claim 6, further comprising a motion sensor coupled to said conveyor assembly, said motion sensor detecting a speed of said conveyor assembly, said motion sensor being operationally coupled to said control wherein a distribution of animal feed onto said conveyor assembly is calculable using data collected from said motion sensor and said load sensing device.

12. The system of claim 6, further comprising a motion sensor coupled to said conveyor assembly, said motion sensor detecting when said conveyor assembly is in motion, said conveyor assembly moving at a constant speed adjacent to said output opening and said motion sensor being operationally coupled to said control wherein a distribution of animal feed onto said conveyor assembly is calculable using data collected from said motion sensor and said load sensing device.

13. The system of claim 1, further comprising a user input, said user input being operationally coupled to said distribution assembly wherein said user input is configured for setting a desired amount of animal feed to be distributed from said distribution vessel through said output opening.

14. The system of claim 5, further comprising:
a user input, said user input being operationally coupled to said distribution assembly wherein said user input is configured for setting a desired amount of animal feed to be distributed from said distribution vessel through said output opening; and
said control being operationally coupled to said user input wherein said control is configured to control metering of the animal feed distributed from said distribution vessel responsive to manipulation of said user input by a user.

15. The system of claim 1, further comprising a storage silo being operationally coupled to said distribution vessel for delivering contents of said storage silo directly into said distribution vessel.

16. The system of claim 1, further comprising said conveyor assembly including a waste conveyor operationally coupled to said trough conveyor such that said waste conveyor is configured to transport unused feed and debris out of said trough conveyor and away from said distribution vessel.

17. The system of claim 14 wherein said waste conveyor has an open distal end relative to said trough conveyor wherein said waste conveyor is configured for delivering unused feed and debris from said trough conveyor into an extrinsic receptacle.

18. The system of claim 1, further comprising a mixer being operationally coupled to said distribution vessel wherein contents of said distribution vessel are mixed by said mixer.

19. The system of claim 18, further comprising said mixer including a grinder wherein said grinder is configured for grinding the animal feed before the animal feed is distributed from said distribution vessel through said output opening.

20. The system of claim 5, further comprising a torque sensor operationally coupled to said trough conveyor, said torque sensor being operationally coupled to said control such that said torque sensor detects torque required for movement of said trough conveyor.

21. A feed distribution system comprising:
a distribution vessel configured for containing and holding animal feed, said distribution vessel having an output opening configured for distributing the animal feed from the distribution vessel;
a conveyor assembly extending from said distribution vessel, said conveyor assembly being positioned proximate to said output opening wherein said conveyor assembly is configured for receiving the animal feed distributed from said distribution vessel, said conveyor assembly including a trough conveyor, said trough conveyor having an upper surface, said upper surface defining a well extending along said trough conveyor wherein said trough conveyor is configured for holding the animal feed therein, said upper surface of said trough conveyor being defined by a belt extending continuously along a length of said trough conveyor;
a distribution control assembly coupled to said distribution vessel, said distribution control assembly being configured for metering distribution of the animal feed from said distribution vessel onto said conveyor assembly;
a motor coupled to said conveyor assembly, said motor moving said belt;
a control operationally coupled to said distribution control assembly and said motor wherein said control coordinates metering of distribution of the animal feed from said distribution vessel and movement of said continuous belt for providing a desired amount of animal feed per unit length of said continuous belt;
a load sensing device operationally coupled to said distribution vessel and said control wherein distribution over time is controlled by said control using weight detected within said distribution vessel by said load sensing device;
a first storage bunker, said first storage bunker being configured for storing a first component of the animal feed;
a first input transport conveyor operationally coupled between said first storage bunker and said distribution vessel wherein said first input transport conveyor is configured for delivering contents of said first storage bunker into said distribution vessel;
a second storage bunker, said second storage bunker being configured for storing a second component of the animal feed;
a second input transport conveyor operationally coupled between said second storage bunker and said distribution vessel wherein said second input transport conveyor is configured for delivering contents from said second storage bunker into said distribution vessel;
a mixer being operationally coupled to said distribution vessel wherein contents of said distribution vessel are mixed by said mixer, said mixer including a grinder wherein said grinder is configured for grinding the animal feed before the animal feed is distributed from said distribution vessel through said output opening;
a motion sensor coupled to said conveyor assembly, said motion sensor detecting when said conveyor assembly is in motion, said conveyor assembly moving at a constant speed adjacent to said output opening and said motion sensor being operationally coupled to said control wherein a distribution of animal feed onto said conveyor assembly is calculable using data collected from said motion sensor and said load sensing device;
a torque sensor operationally coupled to said trough conveyor, said torque sensor being operationally coupled to said control such that said torque sensor detects torque required for movement of said trough conveyor;
a user input, said user input being operationally coupled to said distribution assembly wherein said user input is configured for setting a desired amount of animal feed to be distributed from said distribution vessel through said output opening, said control being operationally coupled to said user input wherein said control is configured to control metering of the animal feed distributed from said distribution vessel responsive to manipulation of said user input by a user;
a storage silo being operationally coupled to said distribution vessel for delivering contents of said storage silo directly into said distribution vessel; and
a waste conveyor operationally coupled to said trough conveyor such that said waste conveyor is configured to transport unused feed and debris out of said trough conveyor and away from said distribution vessel, said waste conveyor has an open distal end relative to said trough conveyor wherein said waste conveyor is configured for delivering unused feed and debris from said trough conveyor into an extrinsic receptacle.
